(19) United States
(12) Patent Application Publication
(10) Pub. No.: US 2013/0114780 A1
(43) Pub. Date: May 9, 2013

(54) NUCLEAR CORE COMPONENT

(71) Applicants: David Anthony Boatwright, (US); Anand Madhav Garde, Columbia, SC (US)

(72) Inventors: David Anthony Boatwright, (US); Anand Madhav Garde, Columbia, SC (US)

(73) Assignee: WESTINGHOUSE ELECTRIC COMPANY LLC, CRANBERRY TOWNSHIP, PA (US)

(21) Appl. No.: 13/288,315

(22) Filed: Nov. 3, 2011

(51) Int. Cl. G21C 7/26; G21C 3/06

(52) U.S. Cl. 376/353; 376/412

(57) ABSTRACT

A fuel rod or control rod for a nuclear reactor that has a spacer interposed between an upper end plug and a plenum spring which extends between the spacer and the fissile or absorber material. Preferably, the spacer is a relatively thin sleeve with a radially extending lip that sits above the coil spring wound at least in part around the sleeve.

### BACKGROUND

1. Field

This invention pertains generally to a pressurized water nuclear reactor fuel assembly and, more particularly, to hermetically sealed rods housing a reactive material that are employed with such a fuel assembly.

2. Description of Related Art

The primary side of nuclear reactor power generating systems which are cooled with water under pressure comprises a closed circuit which is isolated from and in heat exchange relationship with a secondary circuit for the production of useful energy. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water, or borated water, is pumped into the vessel 10 by pump 16 through the core 14 where heat energy is absorbed and is discharged to a heat exchanger 18, typically referred to, as a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by reactor coolant piping 20.

An exemplary reactor design is shown in more detail in FIG. 2. In addition to the core 14 comprised of a plurality of parallel, vertical, co-extending fuel assemblies 22, for purpose of this description, the other vessel internal structures can be divided into the lower internals 24 and the upper internals 26. In conventional designs, the lower internals' function is to support, align and guide core components and instrumentation as well as direct flow within the vessel. The upper internals restrain or provide a secondary restraint for the fuel assembly 22 (only two of which are shown for simplicity in FIG. 2), and support and guide instrumentation and components, such as control rods 28. In the exemplary reactor shown in FIG. 2, coolant enters the reactor vessel through one or more inlet nozzles 30, flows down through an annulus between the reactor vessel and the core barrel, is turned 180° in a lower plenum 34, passes upwardly to a lower support plate 37 and lower core plate 36 upon which the fuel assemblies are seated and through and about the fuel assemblies 22. In some designs, the lower support plate 37 and the lower core plate 36 are replaced by a single structure, a lower core support plate having the same elevation as 37. The coolant flow through the core and surrounding area 38 is typically large on the order of 400,000 gallons per minute at a velocity of approximately 20 feet per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. A support column is aligned above a selected fuel assembly 22 and perforations 42 in the upper core plate 40.

Rectilinearly moveable control rods 28, which typically include a drive shaft 50 and a spider assembly 52 of neutron poison rods, are guided through the upper internals 26 and into aligned fuel assemblies 22 by control rod guide tubes 54. The guide tubes are fixedly joined to the upper support assembly 46 and the top of the upper core plate 40. The support column 48 arrangement assists in retarding guide tube deformation under accident conditions which could detrimentally affect control rod insertion capability.

FIG. 3 is an elevational view, represented in vertically shortened form, of a fuel assembly being generally designated by reference character 22. The fuel assembly 22 is the type used in a pressurized water reactor and has a structural skeleton which, at its lower end, includes a bottom nozzle 58. The bottom nozzle 58 supports the fuel assembly 22 on the lower core plate 36 in the core region of the nuclear reactor. In addition to the bottom nozzle 58, the structural skeleton of the fuel assembly 22 also includes a top nozzle 62 at its upper end and number of guide tubes or thimbles 84 which align with the guide tubes 54 in the upper internals. The guide tubes or thimbles 84 extend longitudinally between the bottom and top nozzles 58 and 62 and at opposite ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. Also, the fuel assembly 22, as shown in FIG. 3, has an instrumentation tube 68 located in the center thereof that extends between and is captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grids 64 spaced along the fuel assembly length. Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material, are responsible for creating the reactive power of the nuclear reactor. The cladding which surrounds the pellets functions as a barrier to prevent the fission by-products from entering the coolant and further contaminating the reactor system.

To control the fission process, a number of control rods 78 are reciprocably moveable in the guide thimbles 84 located at predetermined positions in the fuel assembly 22. Specifically, a rod cluster control mechanism 80, positioned above the top nozzle 62 in selected fuel assemblies, supports a plurality of control rods 78. The control mechanism has an internally threaded cylindrical hub member 82 with a plurality of radially extending flukes or arms 52 that form the spider previously noted with regard to FIG. 2. Each arm 52 is interconnected to a control rod 78 such that the control rod mechanism 80 is operable to move the control rods vertically in the guide thimbles 84 to thereby control the fission process in the fuel assembly 22, under the motive power of a control rod guide shaft 50 which is coupled to the control rod hub 80 all in a well known manner. Like the fuel rod 66, the control rods 78 are formed from an elongated, hollow, tubular cladding that is capped at either end by end plugs that are welded to the cladding. However, instead of fissile material, the reactive elements in a control rod is a neutron absorbing material such as silver-indium-cadmium, which occupies the lower interior region as in the case of fuel rods. During the manufacture of these rods some melting of the springs has been experienced during the tungsten inert gas girth welding process that seals the end plugs to the cladding. Spring melting with the hot end plug and formation of a eutectic can cause rod failures which can release fission by-products into the coolant which would further contaminate the coolant.

Accordingly, a new rod design is desired that will overcome this manufacturing difficulty.

### SUMMARY

The foregoing object is achieved employing a new rod design formed from an elongated tubular cladding having a hollow interior with an axial dimension. A lower end plug closes off one end of the tubular cladding and an upper end plug closes off another end of the tubular cladding. A column of reactive elements occupies a lower portion of the hollow interior of the tubular cladding above the lower end plug and the upper portion of the hollow interior of the tubular cladding forms a gas plenum. A spring extends substantially between a top of the column of reactive elements and the upper end plug and a spacer is situated between the spring and the upper end plug. Preferably, an upper end of the spring that rests against a lower portion of a surface of the spacer is beveled and the thickness of the spacer above the lower portion of the surface of the spacer is greater than the thickness of the beveled upper end of the spring. In one embodiment, the spacer is a sleeve that is encircled by at least a portion of the spring with the sleeve having a radially outwardly extending lip just above an upper end of the spring. Desirably, the lip is approximately between 0.015 inch (0.038 cm) and 0.030 inch (0.076 cm) thick. In still another embodiment, a lower portion of the sleeve is bulged out against the spring and preferably the spring is a coil spring having approximately four closed coils encircling the sleeve. In one embodiment, the rod is a nuclear fuel element and the reactive element is a fissile material. In another embodiment, the rod is a nuclear control rod and the reactive element is a neutron absorbing material. In each case, the spacer insulates the spring against at least a portion of heat applied to the upper end plug. Preferably, the spacer is constructed from a metal selected from the group of materials consisting of zirconium, zirconium alloys, titanium alloys, niobium alloys and chromium alloys and more preferably from one or more of the latter three alloys. The invention also contemplates a nuclear fuel assembly having such a rod.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which the embodiments described hereafter can be applied;

FIG. 2 is an elevation view, partially in section, of a nuclear reactor vessel and internal components to which the embodiments described hereafter can be applied;

FIG. 3 is an elevation view, partially in section, of a fuel assembly illustrated in vertically shortened form, with parts broken away for clarity;

FIG. 4 is a schematic view of a coil spring and spacer that can be employed in the gas plenum of a fuel rod or control rod of the embodiments described hereafter; and

FIG. 5 is a schematic view of the spacer shown in FIG. 4 with a bulging tool inserted within a central opening of the spacer.

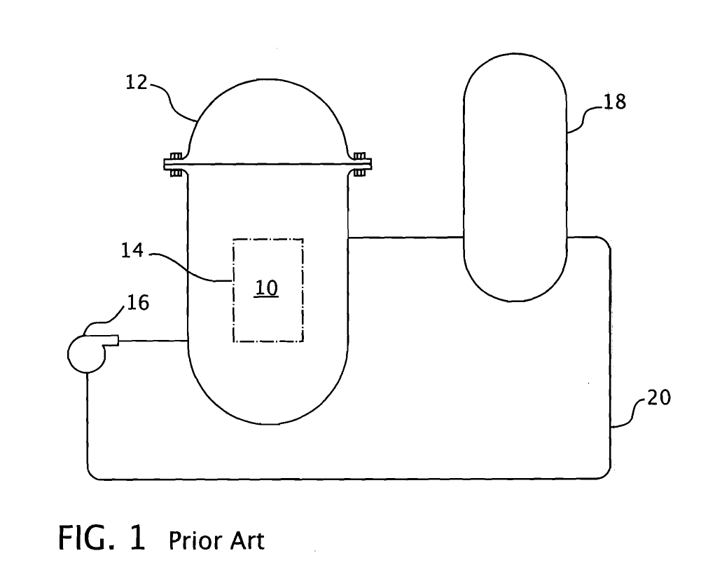

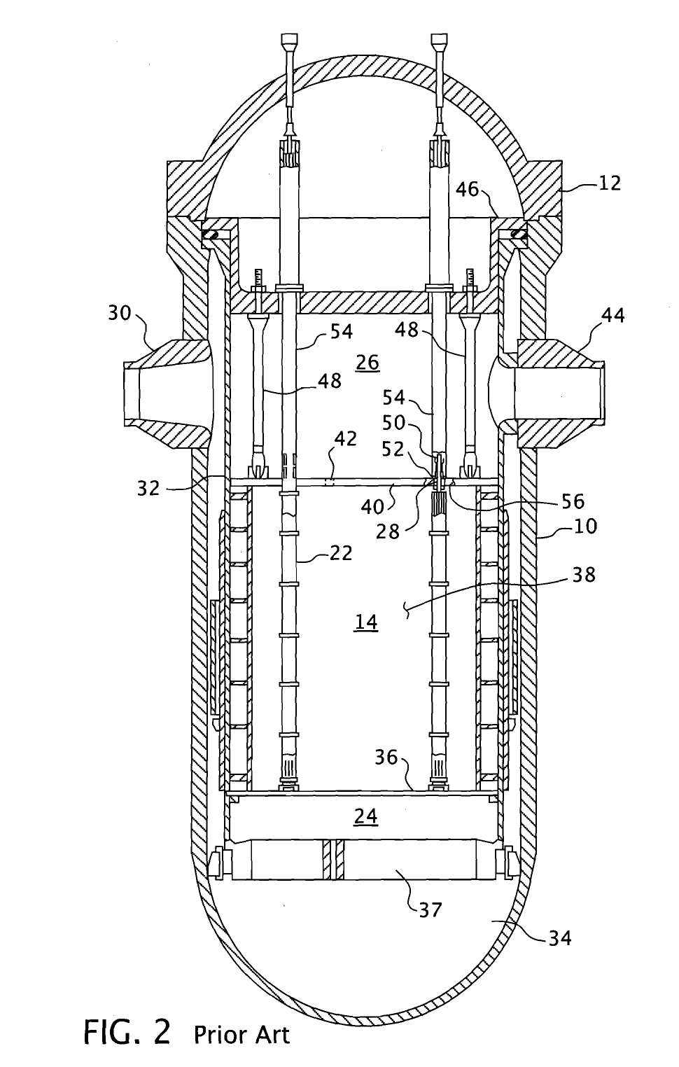

### DESCRIPTION OF THE PREFERRED EMBODIMENT

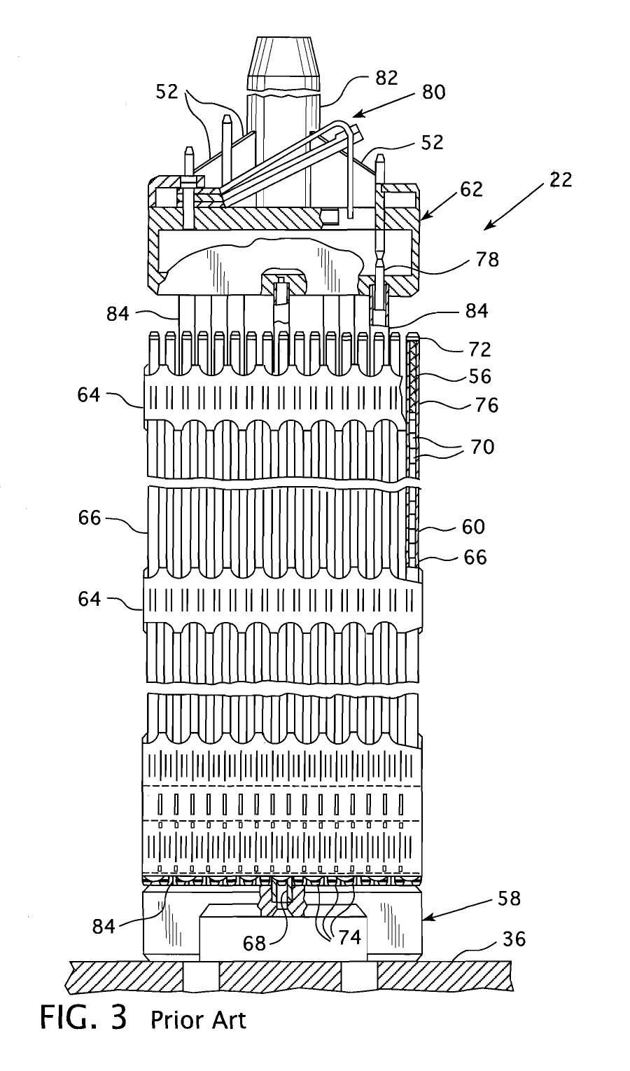

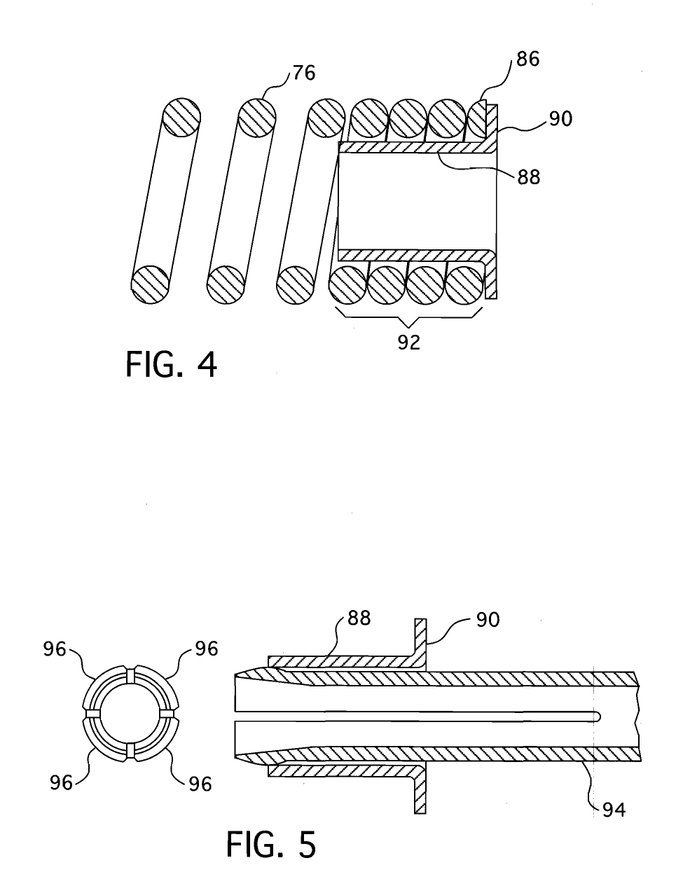

The inventions claimed hereafter provide a new core component for a nuclear reactor and, more particularly, an improved fuel rod or control rod. As previously mentioned with respect to FIG. 3, the fuel rods 66 are basically formed from an elongated hollow tubular cladding 60 that is enclosed at its upper and lower ends respectively by upper end plug 72 and lower end plug 74. The lower portion of the interior of the cladding has a number of fuel pellets 70 which are stacked in tandem and open up to a void region below the upper end plug 72. The void region forms a gas plenum that has a plenum spring 76 extending between the upper plug 72 and the top of the stack of pellets 70. The plenum 56 serves to contain fission gases which are generated during irradiation of the fuel pellets. The construction of a control rod 78 is much the same as that just described for the fuel rod except that the fissile material, i.e., the fuel pellets 70 are exchanged for a neutron absorbing material such as silver-indium-cadmium.

The fuel rod cladding and end plugs are constructed from zirconium alloys and the plenum spring is typically made from 300 stainless steel. The end plugs are sealed to the cladding with a tungsten inert gas girth weld. Experience has shown that if the welding parameters are not set to a low enough temperature in welding the upper end plug some melting of the end of the spring that rests against the upper end plug will occur. If the spring starts to melt it can form a zirconium/iron and zirconium/nickel eutectics that have lower melting points and an affinity for hydrogen. The presence of eutectic and hydriding can adversely affect clad integrity which has to be avoided so that the fission gases are not released into the surrounding environment.

In accordance with one embodiment of the inventions claimed hereafter an upper surface 86 of the plenum spring 76 is feathered or beveled to spread the contact area on the underside of a radially extending lip 90 of a spacer sleeve 88 around which an upper portion 92 of the plenum spring is closely wound. By being closely wound it's meant that the spacing between the coils of the spring around the spacer sleeve 88 is more closely packed than the spacing of the spring coils below the spacer sleeve 88. The spacer sleeve 88 is preferably constructed from a material preferably from the group of metals comprising zirconium, zirconium alloys, titanium alloys, niobium alloys and chromium alloys and most preferably from one or more of the latter three alloys. The spacer sleeve 88 is also preferably thin walled, e.g., between 0.015 inch (0.038 cm) and 0.030 inch (0.076 cm) thick and more preferably between 0.015 inch (0.038 cm) and 0.020 inch (0.051 cm) thick. The sleeve is thin walled to maximize the volume available for the collection of fission by-products and makes it easier to bulge the spacer sleeve into the coils of the plenum spring to secure the coils in close proximity on the spacer sleeve 88. The spacer sleeve 88 presents a heat transfer barrier and reduces the risk of spring melting with the hot end plug and formation of eutectic which can give rise to fuel rod failures. The radially extending lip 90 is inserted between the top of the spring and upper end plug 72 and prevents contact between the top end plug and the spring and the tubular portion of the spacer sleeve helps to dissipate the heat transmitted by the end plug. The lip 90 is thicker than the spring coil feathered end and will resist melting better than the spring, in that the feathered end of the coil tapers down to between approximately 0.002 inches (0.005 cm) and 0.005 inches (0.013 cm) and melts very easily. Without the spacer sleeve insert 88, the weld heat input and temperatures have to be limited which reduces the weld parameter range which does not allow the weld process to be as robust as otherwise possible. If the spacer sleeve 88 is made from a zirconium alloy, some protection against eutectic formation is provided. If the spacer sleeve is made of a titanium alloy, niobium alloy or chromium alloy, no eutectic formation should occur even at high weld heat.

FIG. 5 shows a bulge tool inserted within the spacer sleeve insert 88. The tool 94 can be spread at its lower end by pulling up on a wedge extending axially through the tool and spreading the leaves 96. When the lower end of the spacer sleeve insert 88 is bulged out into the spring, it anchors the sleeve to the spring and captures the spring coils above the bulge.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A rod for use within a core of a nuclear reactor comprising:
an elongated tubular cladding having a hollow interior with an axial dimension;
a lower end plug closing off one end of the tubular cladding;
a column of reactive elements occupying a lower portion of the hollow interior of the tubular cladding above the lower end plug;
a gas plenum occupying an upper portion of the tubular cladding above the column of reactive elements;
an upper end plug closing off another end of the tubular cladding above the gas plenum;
a spring extending substantially between a top of the column of reactive elements and the upper end plug; and
a spacer situated between the spring and the upper end plug.

2. The rod of claim 1 wherein an upper end of the spring rests against a lower portion of a surface of the spacer is beveled and the thickness of the spacer above the lower portion of the surface of the spacer is greater than the thickness of the beveled upper end of the spring.

3. The rod of claim 1 wherein the spacer is a sleeve that is encircled by at least a portion of the spring with the sleeve having a radially outwardly extending lip just above an upper end of the spring.

4. The rod of claim 3 wherein the lip is approximately between 0.015 in (0.038 cm) and 0.030 in (0.076 cm) thick.

5. The rod of claim 3 wherein the lip is between 0.015 in (0.038 cm) and 0.020 in (0.051 cm) thick.

6. The rod of claim 3 wherein the sleeve is between 0.015 in (0.03 cm) and 0.020 in (0.051 cm) thick.

7. The rod of claim 3 wherein a lower portion of the sleeve is bulged out against the spring.

8. The rod of claim 3 wherein the spring is a coil spring having a plurality of closed coils encircling the sleeve.

9. The rod of claim 8 wherein the coils that encircle the sleeve are substantially closely packed together.

10. The rod of claim 8 wherein the spring has approximately four closed coils encircling the sleeve.

11. The rod of claim 1 wherein the spring biases the spacer against the upper end plug.

12. The rod of claim 1 wherein the spacer insulates the spring against at least a portion of heat applied to the upper end plug.

13. The rod of claim 1 wherein the rod is a nuclear fuel element and the reactive elements is a fissile material.

14. The rod of claim 1 wherein the rod is a nuclear control rod and the reactive elements is a neutron absorbing material.

15. The rod of claim 1 wherein the spacer is constructed out of substantially the same material as the cladding.

16. The rod of claim 1 wherein the spacer is constructed out of a material selected from a group of metals comprising zirconium alloys, titanium alloys, niobium alloys and chromium alloys.

17. A nuclear fuel assembly having a fuel rod comprising:
an elongated tubular cladding having a hollow interior with an axial dimension;
a lower end plug closing off one end of the tubular cladding;
a column of reactive elements occupying a lower portion of the hollow interior of the tubular cladding above the lower end plug;
a gas plenum occupying an upper portion of the tubular cladding above the column of reactive elements;
an upper end plug closing off another end of the tubular cladding above the gas plenum;
a spring extending substantially between a top of the column of reactive elements and the upper end plug; and
a spacer situated between the spring and the upper end plug.

18. A control rod assembly for a nuclear reactor having a control rod comprising:
an elongated tubular cladding having a hollow interior with an axial dimension;
a lower end plug closing off one end of the tubular cladding;
a column of absorber elements occupying a lower portion of the hollow interior of the tubular cladding above the lower end plug;
a gas plenum occupying an upper portion of the tubular cladding above the column of reactive elements;
an upper end plug closing off another end of the tubular cladding above the gas plenum;
a spring extending substantially between a top of the column of absorber elements and the upper end plug; and
a spacer situated between the spring and the upper end plug.
